(19) United States
(12) Patent Application Publication
(10) Pub. No.: US 2019/0039422 A1
(43) Pub. Date: Feb. 7, 2019

(54) RUN FLAT SYSTEM INCLUDING A CONTINUOUS ELASTOMERIC CAP MEMBER

(71) Applicant: Hutchinson Industries, Inc., Trenton, NJ (US)

(72) Inventors: Robert W. Swartz, II, Niagra Falls, NY (US); Larry W. Stuck, Amherst, NY (US); John M. Young, Depew, NY (US)

(21) Appl. No.: 16/051,619

(22) Filed: Aug. 1, 2018

Related U.S. Application Data
(63) Continuation of application No. 62/540,800, filed on Aug. 3, 2017.

(51) Int. Cl. B60C 17/06; B60C 17/04

(52) U.S. Cl. CPC B60C 17/06; B60C 17/041

(57) ABSTRACT

A run flat system. The run flat system includes a run flat assembly and a continuous elastomeric cap member. The run flat assembly includes a plurality of arcuate shaped run flat segments which collectively form a ring, and the run flat assembly forms a noncompliant load bearing portion of the run flat system. The continuous elastomeric cap member covers a radially outer surface of the run flat assembly, and the continuous elastomeric cap member forms a compliant portion of the run flat system.

### CROSS-REFERENCE TO RELATED APPLICATIONS

This application claims the benefit under 35 U.S.C. § 119(e) of the earlier filing date of U.S. Provisional Patent Application No. 62/540,800 filed on Aug. 3, 2017, titled RUN FLAT SYSTEM INCLUDING A CONTINUOUS ELASTOMERIC CAP MEMBER, the contents of which are hereby incorporated by reference in their entirety.

### BACKGROUND

This application discloses an invention which is related, generally and in various aspects, to a run flat system which includes a continuous elastomeric cap member.

Run flat devices are designed to provide for flat tire mobility for pneumatic tires used on automobiles, trucks, commercial vehicles, military vehicles and the like. A run flat device is commonly installed in a “well portion” of a wheel. Many applications, particularly for military vehicles, require run flat devices to be light weight and capable of supporting heavy loads. To meet these objectives, it is known to utilize a relatively hard or noncompliant material for the run flat device. The noncompliant material will typically have a durometer harder than the pneumatic tire. The tire durometer typically varies from about 70 Shore A for passenger vehicles to about 50 Shore D for truck size vehicles. Accordingly, it will be appreciated that the quantitative meaning of the terms compliant and noncompliant, as used herein, can vary depending on the specific vehicle application.

The relatively hard or noncompliant material of the run flat device provides for continued operation of a vehicle after a tire blow out, reduced tire pressure or other tire damage. In such situations, however, the run flat device can impact excessively against an interior surface of the tire, and the applied stress between the run flat device and the interior surface of the tire can lead to premature tire liner failure. Similarly, when operating a vehicle on rough terrain, a user often partially deflates the tires of the vehicle to provide better traction and cushion the ride. In this deflated state, the run flat devices can easily nick or cut the tires, thereby leading to premature failure of the tire.

In recognition of these potential issues, Michelin North America, Inc. published a technical bulletin dated Jan. 31, 2010 informing end users of the potential for tire damage when noncompliant devices (e.g., a run flat device) are used in tire wheel assemblies. The Michelin technical bulletin cautioned that the run flat devices must not damage the interior surfaces of the tire during normal operation of the tire wheel assembly, and that damage created by the run flat devices is not a warrantable condition.

To mitigate this potential issue, one approach has been to adhere (e.g., glue) individual rubber segments to radially outermost surfaces of segmented run flat devices (e.g., one individual rubber segment for each segmented run flat device), where the individual rubber segments are collectively intended to serve as a compliant layer and the segmented run flat devices are collectively intended to serve as a load bearing layer as shown in FIG. 1. One example of such an approach is described in U.S. Pat. No. 7,918,255 (the '255 patent). The run flat device of the '255 patent includes (1) at least two rigid support elements which are separated from each other by respective rubber-based resilient layers and (2) a protective layer of rubber that surmounts the radially outermost of the at least two rigid support elements. However, there are multiple shortcomings to utilizing this approach.

First, it is relatively expensive to perform the adhesive bonding process. Second, when operating in a reduced tire pressure situation, there are incredible shear forces which can operate to cause the adhered compliant layer to disengage from the hard material of the run flat device. This shortcoming is also applicable to all approaches that directly adhere a complaint layer (or segments of a compliant layer) to the run flat device (or segments of the run flat device). Third, in many applications, it is desirable to be able to “field mount” the entire run flat system. Without utilizing a segmented run flat device, the entire run flat system would not be field mountable.

What is needed is a run flat system which is field mountable, relatively light in weight, capable of supporting heavy vehicle loads and sufficiently compliant to mitigate potential tire damage.

### BRIEF DESCRIPTION OF THE DRAWINGS

The novel features of the aspects described herein are set forth with particularity in the appended claims. The aspects, however, both as to organization and methods of operation may be better understood by reference to the following description, taken in conjunction with the accompanying drawings.

FIG. 1 illustrates various aspects of a prior art run flat system which includes a compliant layer adhered to a load bearing layer;

FIG. 2 illustrates a cross-section of a high level representation of a run flat system according to various aspects;

FIG. 3 illustrates a partial cross-section of a run flat system of the system of FIG. 2 according to various aspects;

FIG. 4 illustrates tapered trunnion hardware of the run flat system of FIG. 3 according to various aspects;

FIG. 5 illustrates a cross-section of a high level representation of the run flat system of FIG. 2 according to other aspects;

FIG. 6 illustrates a cross-section of a high level representation of the run flat system of FIG. 5 according to yet other aspects; and

FIG. 7 illustrates a cross-section of a partially assembled run flat system according to various aspects.

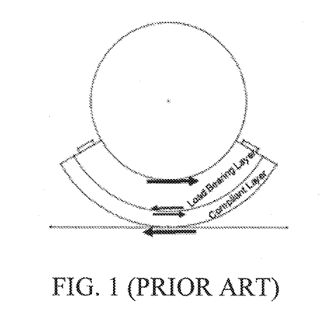

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various aspects of the run flat system in detail, it should be noted that the various aspects disclosed herein are not limited in their application or use to the details of construction and arrangement of parts illustrated in the accompanying drawings and description. Rather, the disclosed aspects may be positioned or incorporated in other aspects, embodiments, variations and modifications thereof, and may be practiced or carried out in various ways. Accordingly, aspects of the run flat system disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as inward, outward, upward, downward, above, below, left, right, interior, exterior, axially, radially and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

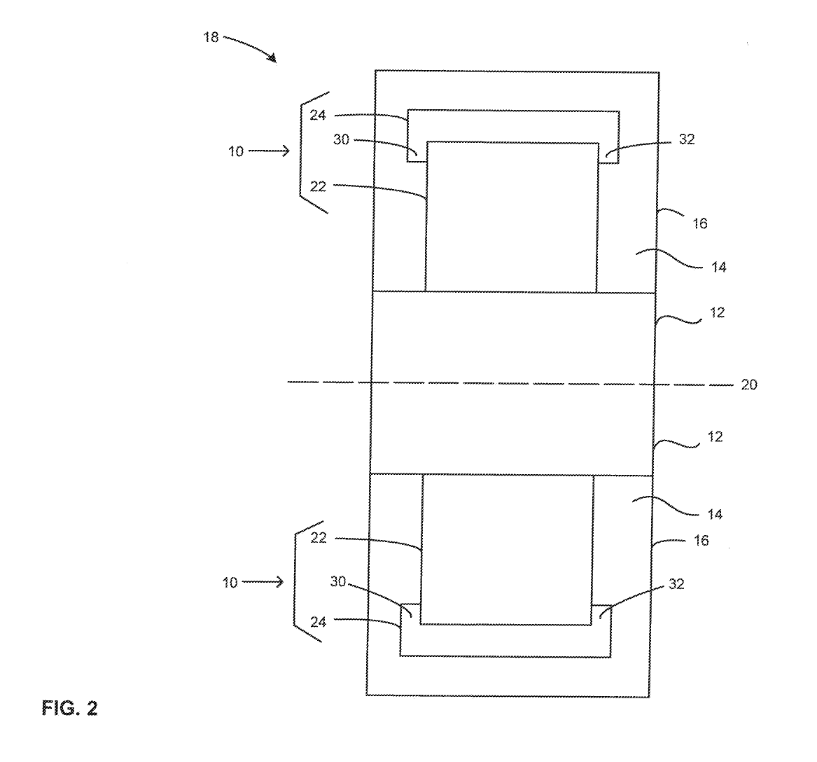

FIG. 2 illustrates a cross-section of a high-level representation of a run flat system 10 according to various aspects. The run flat system 10 is configured for installation around a wheel 12 (e.g., around a drop center of the wheel 12) and within a cavity 14 collectively defined by the wheel 12 and a tire 16 mounted on the wheel 12. The run flat system 10 may be utilized with an automobile, a truck, a commercial vehicle, a military vehicle or the like. According to various aspects, the run flat system 10, the wheel 12 and the tire 16 collectively define a system 18.

The wheel 12 defines an axis of rotation 20, may be any suitable type of wheel and may include any suitable material. For example, according to various aspects, the wheel 12 may be a single-piece wheel or a two-piece or other multipiece wheel, and may include a steel, an aluminum, an alloy and/or combinations thereof. Similarly, the tire 14 may be any suitable type of tire and may include any suitable type of material.

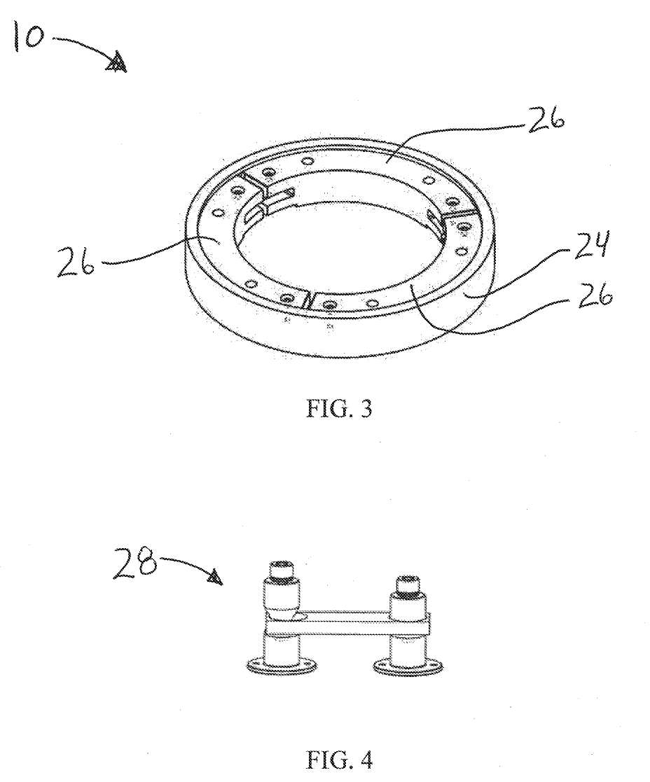

The run flat system 10 is field mountable around the wheel 12 (e.g., around a drop center of the wheel 12) and includes a run flat assembly 22 and a single or continuous elastomeric cap member 24. The run flat assembly 22 includes respective arcuate-shaped run flat segments 26 (See FIG. 3) which are couplable to one another to form a complete ring around the wheel 12 (e.g., around a drop center of the wheel 12). The run flat segments 26 are relatively rigid and may include any suitable material. For example, according to various aspects, the durometer of the run flat segments 26 are typically much harder than the tire 16 and are typically about 55 Shore D or harder, and the run flat segments 26 include a noncompliant material made of various thermoplastic or thermoset materials. These run flat materials can include, but are not limited to, harder rubber materials, copolyesters like Hytrel® (commercially available from E. I. du Pont de Nemours and Company), urethanes, nylon and/or other similar materials.

Collectively, the run flat segments 26 operate as a load bearing portion of the run flat system 10. It is known that the load bearing strength of the run flat assembly 22 changes in relative proportion to the durometer of the run flat material of the run flat segments 26. Although three run flat segments 26 are shown in FIG. 3 as forming the ring-shaped run flat assembly 22, it will be appreciated that any number of run flat segments 26 may be utilized to form the ring-shaped run flat assembly 22. Also, although the run flat segments 26 are shown in FIG. 2 as having a substantially rectangular cross-section, it will be appreciated that the run flat segments 26 may have cross-sections other than rectangular. For example, according to various aspects, the radially innermost surface of the run flat segments 26 may be wider than the radially outermost surface of the run flat segments 26, thereby providing the run flat segments 26 with a trapezoidal cross-section. Such aspects may be utilized, for example, to allow the run flat assembly 22 to also provide bead lock functionality.

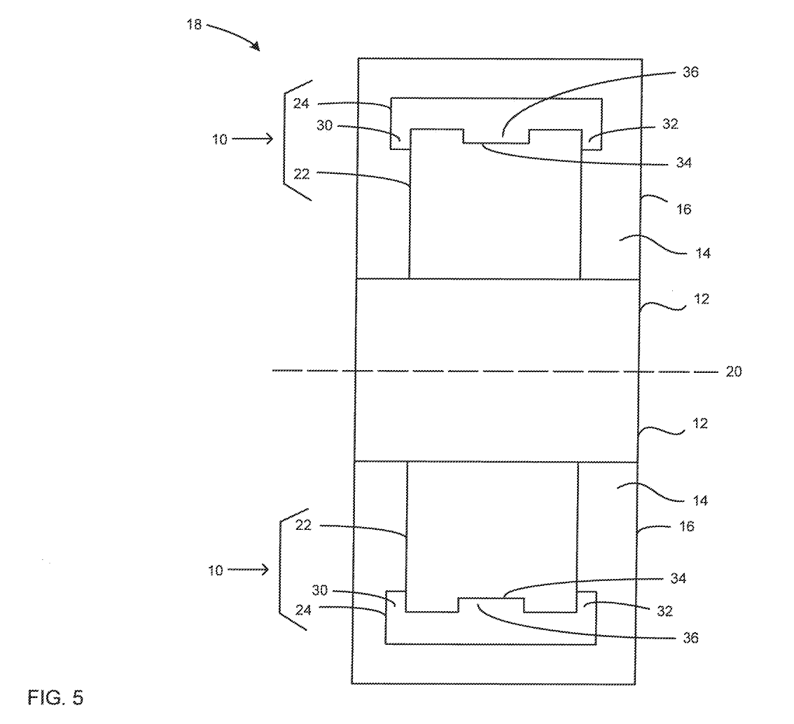

The respective run flat segments 26 may be coupled to one another in any suitable manner. For example, according to various aspects, the run flat segments 26 may be coupled to one another by quick-to-install tapered trunnion hardware 28 (See FIG. 4) or similar radial tightening hardware. According to other aspects, the run flat segments 26 may be coupled to one another by means other than the trunnion hardware 28 or similar radial tightening hardware. Additional aspects of the run flat segments 26 will be described in more detail with reference to FIG. 5.

The elastomeric cap member 24 is a single, continuous cap member which covers an outer radial surface of the run flat assembly 22 (See FIG. 3). The elastomeric cap member 24 operates as a compliant portion of the run flat system 16 and may include any suitable material. For example, according to various aspects, the durometer of the “compliant” elastomeric cap member 24 is in the range of about 70 Shore A to 80 Shore A to prevent tire damage, and the “compliant” elastomeric cap member 24 can include one or more various rubbers (natural rubber, buna rubber, etc.), urethane and/or similarly compliant elastomers. Thus, it will be appreciated that the elastomeric cap member 24 can include a variety of different material configurations.

According to various aspects, to achieve compliance and field mountability, the elastomeric cap member 24 can be stretched or otherwise tightened over the harder run flat segments 26. For the aspects shown in FIG. 2, the elastomeric cap member 24 is configured to fit directly over a smooth circumferential surface of the run flat segments 26. As the elastomeric cap member 24 is not adhered or molded to the run flat segments 26, the elastomeric cap member 24 enjoys freedom of movement relative to the run flat assembly 22 in that the elastomeric cap member 24 can rotate freely around the circumference of the run flat assembly 22 (can move circumferentially relative to the run flat assembly 22). Stated differently, the run flat assembly 22 and the composite elastomeric cap member 24 can rotate about the axis of rotation 20 at different velocities.

Additionally, according to various aspects, the elastomeric cap member 24 defines a first leg member 30 and a second leg member 32 as shown in FIG. 2. The first leg member 30 is configured to cover a portion of an axially outboard side of the run flat assembly 22, and the second leg member 32 is configured to cover a portion of an axially inboard side of the run flat assembly 22. The first and second leg members 30, 32 provide further protection against lateral forces applied to the run flat system 10 and help to keep the elastomeric cap member 24 properly positioned relative to the run flat assembly 22.

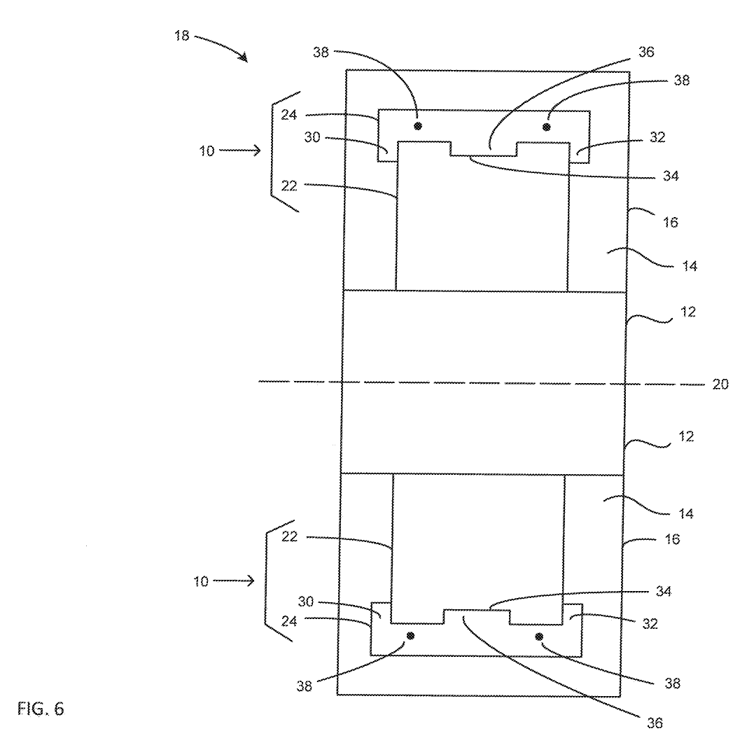

While the run flat system 10 shown in FIG. 2 will function well for many applications (with or without the first and second leg members 30, 32), there are some applications which can benefit from additional aspects of the elastomeric cap member 24 and the run flat assembly 22. As described in more detail below with respect to FIGS. 5 and 6, various aspects of the elastomeric cap member 24 and the run flat assembly 22 provide for a “stronger coupling” between the run flat assembly 22 and the elastomeric cap member 24.

FIG. 5 illustrates a cross-section of a high level representation of the run flat system 10 according to other aspects. For the aspects shown in FIG. 5, the run flat segments 26 are as described above, but each run flat segment 26 also defines a groove 34 which is configured to receive the elastomeric cap member 24. Each groove 34 is machined or molded into a respective hard, run flat segment 26 and the grooves 34 may be of any suitable cross-section (e.g., rectangular, trapezoidal, etc.). It will be appreciated that the respective grooves 34 defined by the respective run flat segments 26 align with one another and collectively extend along a circumference of the ring formed by the coupled run flat segments 26. Although only one groove 34 is shown in the cross-section of FIG. 5, it will be appreciated that the run flat segments 26 may define any number of grooves 34 configured to receive the elastomeric cap member 24.

For the aspects shown in FIG. 5, the elastomeric cap member 24 is as described above, but the elastomeric cap member 24 also defines a tongue member 36 which is configured to be received by the respective grooves 34 of the run flat assembly 22. The tongue member 36 has a cross-section which corresponds to the cross-section of the grooves 34 of the run flat assembly 22. However, the cross-section area of the tongue member 36 is slightly smaller than the cross-section area of the grooves 34 of the run flat assembly 22. Thus, when the tongue member 36 is received by the grooves 34 of the run flat assembly 22, a slip fit is formed between the elastomeric cap member 24 and the run flat assembly 22. The nature of this slip fit allows the elastomeric cap member 24 to enjoy freedom of movement relative to the run flat assembly 22 in that the elastomeric cap member 24 can rotate freely around the circumference of the run flat assembly 22 (can move circumferentially relative to the run flat assembly 22). Stated differently, the run flat assembly 22 and the composite elastomeric cap member 24 can rotate about the axis of rotation 20 at different velocities.

Although only one tongue member 36 is shown in FIG. 5, it will be appreciated that the elastomeric cap member 24 may include more than one tongue member 36 (i.e., one tongue member 36 for each circumferential groove 34 defined by the run flat assembly 22). As compared to the aspects shown in FIG. 2, the “tongue and groove” fitment arrangement of the run flat system 10 shown in FIG. 5 helps to reduce the possibility of the elastomeric cap member 24 from being disengaged prematurely in more aggressive impact events. The “tongue and groove” fitment arrangement, as well as the configuration of the first and second leg members 30, 32, helps to protect against lateral forces applied to the run flat system 10 and helps to keep the elastomeric cap member 24 properly positioned relative to the run flat assembly 22 at all times.

According to various aspects, the elastomeric cap member 24 for the aspects shown in FIG. 2 or FIG. 5 can further include a composite stiffening material embedded therein. The composite stiffening material can include a cable fiber like Kevlar® (commercially available from E. I. du Pont de Nemours and Company) or a similar material as described below. The composite stiffening material can also be a metal insert, or various other glass or fabric fillers. The inclusion of the composite stiffening material restrains the elastomeric cap member 24 during aggressive applications which subject the elastomeric cap member 24 to extreme shear forces which could lead to potential disengagement of the elastomeric cap member 24 from the run flat assembly 22. An example of the elastomeric cap member 24 including such composite stiffening material is described below with respect to FIG. 6.

FIG. 6 illustrates a cross-section of a high level representation of the run flat system 10 according to yet other aspects. For the aspects shown in FIG. 6, the elastomeric cap member 24 is as described above, but the elastomeric cap member 24 further includes cable members 38 which are embedded into the elastomeric cap member 24 and surround the run flat assembly 22 (the cable members 38 form rings around the run flat assembly 22). Although only two cable members 38 are shown in FIG. 6, it will be appreciated that the elastomeric cap member 24 may include any number of cable members 38. The cable members 38 may include any suitable material. For example, according to various aspects, the cable members 38 include Kevlar® (commercially available from E. I. du Pont de Nemours and Company) or a similar material. The combination of (1) the cable members 38 and (2) the elastomeric cap member 24 being able to rotate freely around the run flat assembly 22 negates any danger of the elastomeric cap member 24 circumferentially loosening (e.g., expanding and creeping radially outward relative to the axis of rotation 20) and coming off the run flat assembly 22. Even with the cable members 38, the elastomeric cap member 24 is (1) sufficiently flexible to allow it to be installed as a single piece and (2) sufficiently compliant enough to protect the interior surface of the tire 16 from damage.

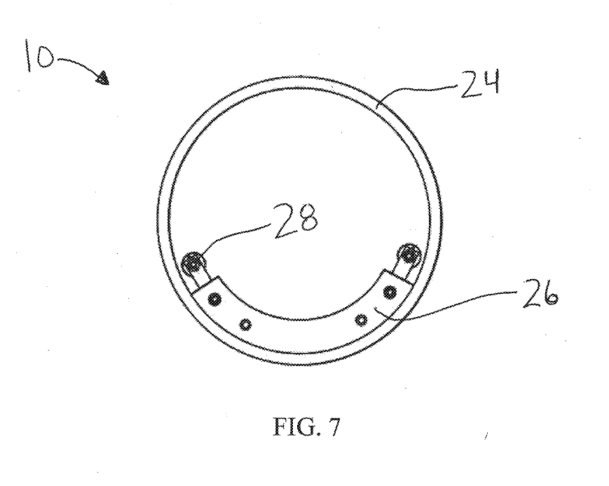

FIG. 7 illustrates a cross-section of a partially installed run flat system 10 according to various aspects. For purposes of clarity, neither the wheel 12 nor the tire 16 are shown in FIG. 7. According to various aspects, to install the run flat system 10, the elastomeric cap member 24 is first folded and placed inside the cavity 14 by hand. The first one of the run flat segments 26 is then slid into the cavity 14 and positioned such that the tongue member 36 of the elastomeric cap member 24 is received by the groove 34 of the first one of the run flat segments 26 (the groove 34 and the tongue member 36 are hidden from view in FIG. 7).

Once the first one of the run flat segments 26 is properly positioned, the second one of the run flat segments 26 (not shown in FIG. 7) is then slid into the cavity 14 and positioned such that the tongue member 36 of the elastomeric cap member 24 is received by the groove 34 of the second one of the run flat segments 26. The first and second ones of the run flat segments 26 may then be coupled to one another by suitable hardware such as the tapered trunnion hardware 28 or similar radial tightening hardware.

Once the first and second ones of the run flat segments 26 are properly positioned, the third one of the run flat segments 26 may then be slid into the cavity 14 and positioned such that the tongue member 36 of the elastomeric cap member 24 is received by the groove 34 of the third one of the run flat segments 26. The third one of the run flat segments 26 may then be coupled to the first and second ones of the run flat segments 26 by suitable hardware such as the tapered trunnion hardware 28 or similar radial tightening hardware.

Alternatively, according to other aspects, all of the run flat segments 26 can be slid into the cavity 14, then all of the run flat segments 26 can be positioned such that the tongue member 36 of the elastomeric cap member 24 is received by the grooves 34 of the respective run flat segments 26, then all of the run flat segments 26 can be coupled together by suitable hardware such as the tapered trunnion hardware 28 or similar outboard tightening hardware.

After the tapered trunnion hardware 28 or similar outboard tightening hardware are installed, the run flat segments 26 cannot be removed from the elastomeric cap member 24 without first removing the tapered trunnion hardware 28 or similar radial tightening hardware.

### EXAMPLES

### Example 1

A run flat system is provided. The run flat system comprises a run flat assembly and a continuous elastomeric cap member. The run flat assembly comprises a plurality of arcuate shaped run flat segments which collectively form a ring, wherein the run flat assembly forms a noncompliant load bearing portion of the run flat system. The continuous elastomeric cap member covers a radially outer surface of the run flat assembly, wherein the continuous elastomeric cap member forms a compliant portion of the run flat system.

### Example 2

The run flat system of Example 1, wherein a hardness of the run flat assembly is greater than a hardness of a tire associated with the run flat system.

### Example 3

The run flat system of Example 2, wherein the hardness of the run flat assembly is at least 55 Shore D.

### Example 4

The run flat system of Examples 1, 2 or 3, wherein each run flat segment defines a groove which receives the continuous elastomeric cap member.

### Example 5

The run flat system of Examples 1, 2, 3 or 4, wherein the run flat assembly further comprises hardware configured to couple a first one of the run flat segments with a second one of the run flat segments.

### Example 6

The run flat system of Examples 1, 2, 3, 4 or 5, wherein the continuous elastomeric cap member is able to move circumferentially relative to the run flat assembly.

### Example 7

The run flat system of Examples 1, 2, 3, 4, 5 or 6, wherein a a hardness of the continuous elastomeric cap member is less than a hardness of a tire associated with the run flat system.

### Example 8

The run flat system of Example 7, wherein the hardness of the continuous elastomeric cap member is in the range of 70 Shore A to 80 Shore A.

### Example 9

The run flat system of Examples 1, 2, 3, 5, 6, 7 or 8, wherein the continuous elastomeric cap member defines a tongue member which is received by grooves defined by the respective run flat segments.

### Example 10

The run flat system of Examples 1, 2, 3, 4, 5, 6, 7, 8 or 9, wherein the continuous elastomeric cap member defines (1) a first leg member which covers at least a portion of an axially outboard side of the run flat assembly and (2) a second leg member which covers at least a portion of an axially inboard side of the run flat assembly.

### Example 11

The run flat system of Examples 1, 2, 3, 4, 5, 6, 7, 8, 9 or 10, wherein the continuous elastomeric cap member is slip fit with the run flat assembly.

### Example 12

The run flat system of Examples 1, 2, 3, 4, 5, 6, 7, 8, 9, 10, or 11, wherein the continuous elastomeric cap member comprises a composite stiffening material.

### Example 13

The run flat system of Examples 1, 2, 3, 4, 5, 6, 7, 8, 9, 10, 11 or 12, wherein the continuous elastomeric cap member comprises at least one cable member which surrounds the run flat assembly.

### Example 14

The run flat system of Examples 1, 2, 3, 4, 5, 6, 7, 8, 9, 10, 11, 12 or 13, wherein the run flat system is field mountable within a cavity defined by a wheel and a tire mounted on the wheel.

### Example 15

A system is provided. The system comprises a wheel, a tire mounted to the wheel, and a run flat system. The wheel defines an axis of rotation. The wheel and tire collectively define a cavity. The run flat system is positioned within the cavity, is field mountable and comprises (1) a run flat assembly and (2) a continuous elastomeric cap member. The run flat assembly comprises a plurality of arcuate shaped noncompliant run flat segments which collectively form a ring, wherein each run flat segment defines a groove. The continuous elastomeric cap member covers a radially outer surface of the run flat assembly, wherein the continuous elastomeric cap member defines a tongue member which is received by the grooves of the respective run flat segments. The continuous elastomeric cap member is able to move circumferentially relative to the run flat assembly.

### Example 16

The system of Example 15, wherein the continuous elastomeric cap member further defines (1) a first leg member which covers at least a portion of an axially outboard side of the run flat assembly and (2) a second leg member which covers at least a portion of an axially inboard side of the run flat assembly.

### Example 17

The system of Examples 15 or 16, wherein the continuous elastomeric cap member comprises a composite stiffening material.

### Example 18

The system of Examples 15, 16 or 17, wherein the continuous elastomeric cap member comprises at least one cable member which surrounds the run flat assembly.

### Example 19

The system of Examples 15, 16, 17 or 18, wherein the continuous elastomeric cap member is slip fit with the run flat assembly.

### Example 20

The system of Examples 15, 16, 17, 18 or 19, wherein (1) the run flat assembly comprises a load bearing portion of the run flat system and (2) the continuous elastomeric cap member comprises a compliant portion of the run flat system.

Although the various aspects of the system have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A run flat system, comprising:
a run flat assembly comprising a plurality of arcuate shaped run flat segments which collectively form a ring, wherein the run flat assembly forms a noncompliant load bearing portion of the run flat system; and
a continuous elastomeric cap member covering a radially outer surface of the run flat assembly, wherein the continuous elastomeric cap member forms a compliant portion of the run flat system.

2. The run flat system of claim 1, wherein a hardness of the run flat assembly is greater than a hardness of a tire associated with the run flat system.

3. The run flat system of claim 2, wherein the hardness of the run flat assembly is at least 55 Shore D.

4. The run flat system of claim 1, wherein each run flat segment defines a groove which receives the continuous elastomeric cap member.

5. The run flat system of claim 1, wherein the run flat assembly further comprises hardware configured to couple a first one of the run flat segments with a second one of the run flat segments.

6. The run flat system of claim 1, wherein the continuous elastomeric cap member is able to move circumferentially relative to the run flat assembly.

7. The run flat system of claim 1, wherein a hardness of the continuous elastomeric cap member is less than a hardness of a tire associated with the run flat system.

8. The run flat system of claim 7, wherein the hardness of the continuous elastomeric cap member is in the range of 70 Shore A to 80 Shore A.

9. The run flat system of claim 1, wherein the continuous elastomeric cap member defines a tongue member which is received by grooves defined by the respective run flat segments.

10. The run flat system of claim 1, wherein the continuous elastomeric cap member defines:
a first leg member which covers at least a portion of an axially outboard side of the run flat assembly; and
a second leg member which covers at least a portion of an axially inboard side of the run flat assembly.

11. The run flat system of claim 1, wherein the continuous elastomeric cap member is slip fit with the run flat assembly.

12. The run flat system of claim 1, wherein the continuous elastomeric cap member comprises a composite stiffening material.

13. The run flat system of claim 1, wherein the continuous elastomeric cap member comprises at least one cable member which surrounds the run flat assembly.

14. The run flat system of claim 1, wherein the run flat system is field mountable within a cavity defined by a wheel and a tire mounted on the wheel.

15. A system, comprising:
a wheel, wherein the wheel defines an axis of rotation;
a tire mounted to the wheel, wherein the wheel and tire collectively define a cavity; and
a run flat system positioned within the cavity, wherein the run flat system is field mountable and comprises:
a run flat assembly comprising a plurality of arcuate shaped noncompliant run flat segments which collectively form a ring, wherein each run flat segment defines a groove; and
a continuous elastomeric cap member covering a radially outer surface of the run flat assembly, wherein the continuous elastomeric cap member defines a tongue member which is received by the grooves of the respective run flat segments,
wherein the continuous elastomeric cap member is able to move circumferentially relative to the run flat assembly.

16. The system of claim 15, wherein the continuous elastomeric cap member further defines:
a first leg member which covers at least a portion of an axially outboard side of the run flat assembly; and
a second leg member which covers at least a portion of an axially inboard side of the run flat assembly.

17. The system of claim 15, wherein the continuous elastomeric cap member comprises a composite stiffening material.

18. The system of claim 15, wherein the continuous elastomeric cap member comprises at least one cable member which surrounds the run flat assembly.

19. The system of claim 15, wherein the continuous elastomeric cap member is slip fit with the run flat assembly.

20. The system of claim 15, wherein:
the run flat assembly comprises a load bearing portion of the run flat system; and
the continuous elastomeric cap member comprises a compliant portion of the run flat system.
